(19) United States
(12) Patent Application Publication
(10) Pub. No.: US 2006/0139448 A1
(43) Pub. Date: Jun. 29, 2006

(54) 3D displays with flexible switching capability of 2D/3D viewing modes

(75) Inventors: Victor Hyeong-Seok Ha, Irvine, CA (US); Ning Xu, Irvine, CA (US); Yeong-Taeg Kim, Irvine, CA (US)

Correspondence Address: MYERS DAWES ANDRAS & SHERMAN, LLP, 19900 MACARTHUR BLVD.,, SUITE 1150, IRVINE, CA, 92612, US

(73) Assignee: Samsung Electronics Co., Ltd., Suwon City (KR)

(21) Appl. No.: 11/025,109

(22) Filed: Dec. 29, 2004

(51) Int. Cl. H04N 13/04; H04N 15/00

(52) U.S. Cl. 348/51

(57) ABSTRACT

A display system that displays a mixture of 2D and 3D video content is provided. A switching mechanism in the display system turns the 2D/3D mode of different portions of the screen on and off independently and automatically. Any type (2D, 3D, mixed) of video content can be displayed on any part of the screen simultaneously. The switching between different modes (2D, 3D, mixed) is performed automatically according to input control signals received from an internal device, or determined by a 2D/3D content detector in a computer, set-top-box, and/or cable/satellite tuner/receiver.

### FIELD OF THE INVENTION

The present invention relates to displaying 2D/3D images, and in particular to displaying arbitrary 2D/3D mixture of video signals at any portion of the display at any time.

### BACKGROUND OF THE INVENTION

Three-dimensional displays are finding their way into the consumer electronics market. There are a variety of 3D display techniques including autostereoscopy, holography, integral imaging, etc. The 3D displays are applied to many applications such as movies, TV, mobile phones, games, and PC monitors.

Currently, image/video contents are generated in either a 2D or 3D format. The display monitors/TVs then display these contents either in 2D or 3D display mode. The switching between these two modes is possible for some monitors/TVs via a manual control (e.g., mechanical or electrical switch or button) from the viewer/user. However, such manual control becomes very difficult or impossible if (1) the viewer/user has no knowledge of the 2D/3D display mode of the incoming video content, (2) the 2D/3D display mode changes very quickly, or (3) the video content has a mixture of 2D and 3D modes. The 2D video contents displayed in 3D mode are distorted and lose clarity, brightness, and resolution. Appropriate automatic switching is therefore desired to display 2D video contents in 2D mode and, similarly, to display 3D video contents in 3D mode.

When producing video contents for 3D-enabled displays, the producer may desire to freely mix and combine 2D and 3D visual objects/scenes/contents in time, space, or both. For some applications, it may arise naturally to display scenes that are made of a mixture of 2D and 3D objects, e.g., watching a streaming 3D video within the 2D interface to a windows-based operating system.

There is, therefore, a need for a flexible 3D display method that can display 2D, 3D, or mixed image/video content on any portion of the screen at any given time, with a flexible switching (turn on/off) capability of the 2D/3D display modes.

### BRIEF SUMMARY OF THE INVENTION

The present invention addresses the above needs. In one embodiment the present invention provides a display system and method for flexible 3D display of 2D, 3D, or mixed image/video content on any portion of the screen at any given time, with a flexible switching (turn on/off) capability of the 2D/3D display modes. This allows a mixture of 2D and 3D contents to be displayed on the screen, with clear viewing of both 2D and 3D contents.

Switching means in the display system turning the 2D/3D mode of different portions of the screen on and off independently and automatically. Any type (2D, 3D, mixed) of video content can be displayed on any part of the screen simultaneously. The switching between different modes (2D, 3D, mixed) is performed automatically according to input control signals received from an internal device, or determined by a 2D/3D content detector in a computer, set-top-box, and/or cable/satellite tuner/receiver.

Other embodiments, features and advantages of the present invention will be apparent from the following specification taken in conjunction with the following drawings.

### BRIEF DESCRIPTION OF THE DRAWINGS

FIG. 1 shows a functional block diagram of an embodiment of a display system according to the present invention;

FIG. 2A shows example horizontal parallax with the switching unit being the entire screen in 2D mode in the system of FIG. 1;

FIG. 2B shows example horizontal parallax with the switching unit being the entire screen in 3D mode in the system of FIG. 1;

FIG. 3A shows example horizontal parallax with the switching unit being an M by N window as entire screen in 2D mode in the system of FIG. 1;

FIG. 3B shows an example where the entire screen containing 2 M by N windows that are in 3D mode, and the rest of the screen is in 2D mode;

FIG. 4A shows example horizontal parallax with an arbitrary switching unit being the entire screen in 2D mode in the system of FIG. 1;

FIG. 4B shows example horizontal parallax with an arbitrary switching unit wherein an arbitrary region is in 3D mode (hashed area) in the system of FIG. 1;

FIG. 5 shows an example of generating autostereoscopy with a parallax barrier in the system of FIG. 1;

FIG. 6 shows an example of a flexible switching display in the system of FIG. 1;

FIG. 7 shows an example parallax barrier placed behind image pixel in the system of FIG. 1;

FIG. 8 shows an example Ferroelectric Liquid Crystal Cell for the system of FIG. 1;

FIG. 9 shows an example mixed 2D/3D mode video with two 3D display regions;

FIG. 10 shows a functional block diagram on an embodiment of the switch control map generator in the system of FIG. 1;

FIG. 11 shows a functional block diagram on an embodiment of the content detector of FIG. 11;

FIG. 12 shows a functional block diagram of an embodiment of a 2D/3D Content Segmentation unit of FIG. 11; and

FIG. 13 shows a functional block diagram of an embodiment of the switch controller of FIG. 1.

### DETAILED DESCRIPTION OF THE INVENTION

In one embodiment, the present invention provides a flexible 3D display method and system for flexible display of arbitrary 2D/3D mixture of video signals on any portion of the display at any time. The 2D/3D mixture of video signals can be obtained by multiplexing/combining 2D and 3D objects/scene/contents temporally, spatially, or both. The input is the video signal of any type (2D, 3D, or mixed). The output is appropriate 2D/3D objects/scenes displayed at the corresponding portions of the screen.

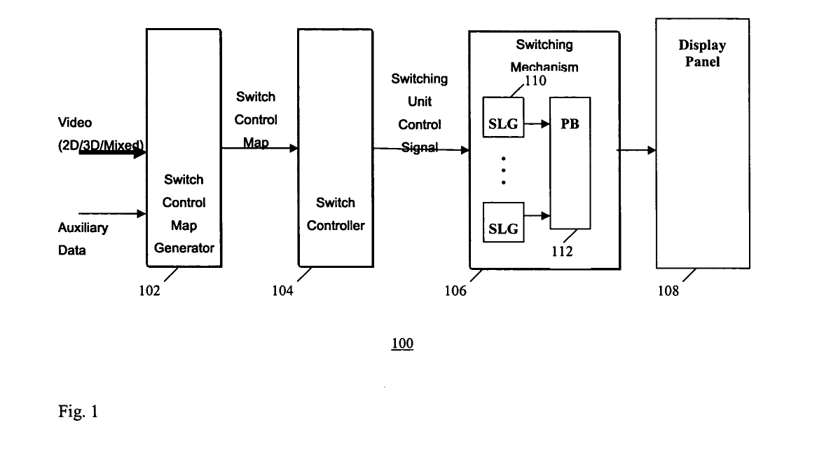

Referring to the block diagram in FIG. 1, an embodiment of a 3D display system 100 with flexible switching of 2D/3D viewing mode according to the present invention, comprises functional elements: a Switch Control Map Generator 102; a Switch Controller 104; a Switching Mechanism 106; and a Display Panel 108 (e.g., LCD or equivalents). In one embodiment, the Switching Mechanism 106 comprises: Switching Light Generators 110 and a Parallax Barrier (PB) 112 or equivalents.

The 3D display system 100, utilizes a set of control signals that indicate which parts of a display screen should be in 3D mode for the given scene/image at a given time. This set of control signals are generated by a device/algorithm either within, or outside, the 3D display system 100. The control signals are delivered to the switching mechanism 106 at an appropriate time and rate to meet the frame refresh rate of the display panel 108.

The control signals activate a set of switches (e.g., logical/software switches 110) that toggle each pixel or “switching unit” of the display screen 108 from the 2D mode to 3D mode, and vice versa. In one example, a control signal is defined as a binary signal with values of “1” or “0”, where the value of “1” represents the 3D mode while the value of “0” represents the 2D mode at the corresponding pixel/switching unit location(s). As those skilled in the art recognize, other control signal examples are possible.

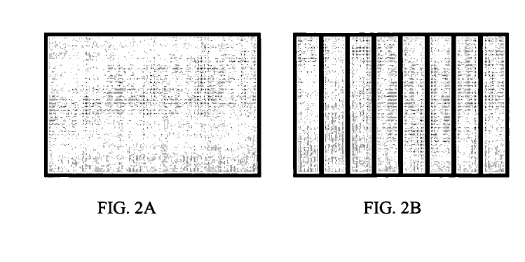

In one implementation, the set of switches 110 are connected to e.g. a parallax barrier 112 that enables 3D viewing. The set of switches 110 can also be connected to any other device, such as a lenslet sheet and a lenslet array, etc., with similar functionality of enabling/disabling 3D viewing. Each switch controls the 2D/3D viewing mode of a “switching unit” on the display panel 108 where this “switching unit” is defined as the smallest region that is capable of switching between 2D/3D modes independently. The size and shape of the “switching unit” may vary. For example, if the switching unit is defined to be the entire display screen on the display panel 108, the switch turns on and off the 2D/3D viewing modes for the entire screen. FIGS. 2A-B show examples of mode change in the parallax barrier 112 reflecting said example, wherein FIG. 2A shows the entire screen in 2D mode, while FIG. 2B shows the entire screen in 3D mode (shown as hashed-marked area).

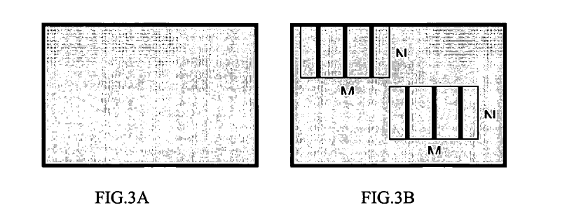

If the switching unit is defined to be a M-pixel by N-pixel rectangular window, as shown by example in FIGS. 3A-B, the switch turns on and off the 2D/3D viewing mode of each of these rectangular windows. FIG. 3A shows the entire screen in 2D mode, whereas FIG. 3B shows two M-by-N windows in 3D mode.

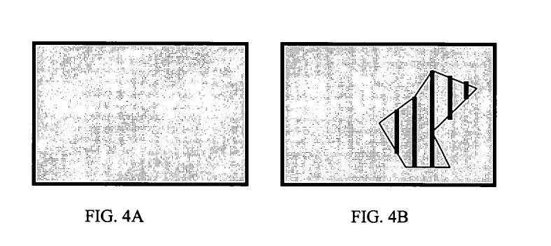

The switching unit can also overlap with neighboring switching units at varying degrees to form a more flexible shape and size. To increase the flexibility of the display screen further to its maximum capacity, the “switching unit” can be defined as any vertical or horizontal pair of pixels that are spatially consecutive to each other. This small switching unit allows a very flexible display with an arbitrary shape and size of 3D objects/scenes within the screen. An example in FIG. 4A shows the entire screen in 2D mode, whereas an example in FIG. 4B shows an arbitrary screen region in 3D mode.

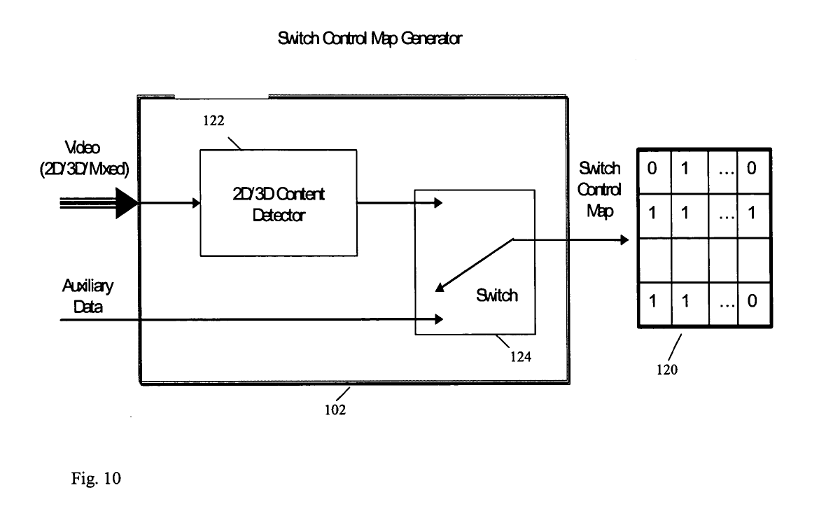

Referring back to FIG. 1, in one embodiment, the Switch Control Map Generator (SCMG) 102 inputs a stream of video signals with 2D, 3D, or mixed 2D/3D contents (an optional input can be auxiliary data), and outputs a switch control map comprising bitmap of switch control signals. FIG. 10 shows an example implementation of the SCMG 102 that outputs an example switch control map 120. The example SCMG 102 comprises a 2D/3D Content Detector 122 that detects 2D vs. 3D content of the video input and outputs “0” for 2D mode, and “1” for 3D mode, to generate the control bitmap 120 as an array of binary values, “1” of “0”. Each binary value in the bitmap 120 corresponds to, and controls, the 2D/3D viewing mode of a pixel or switching unit in the display apparatus 108 (FIG. 1).

Using the control bitmap 120, the Switch Controller 104 (FIG. 1) operates such that a pixel or switching unit in the display panel 108 that corresponds to the binary value “1” is switched to 3D mode, and a pixel or switching unit that corresponds to the binary value “0” is switched to 2D mode.

The Auxiliary Data input of the SCMG 102, when present, provides an external switch control map (similar to the map 102) that is pre-computed e.g. by the content producer of the input video. In that case, the SCMG 102 is placed in “bypass mode”, wherein a switch 124 in the SCMG 102 essentially connects the Auxiliary Data input to the Switch Controller 104 (FIG. 1) such that the SCMG 102 functions only as a connecting medium from the auxiliary data input to the Switch Controller 104.

If there is no such Auxiliary Data supplied at the auxiliary input of the SCMG 102, then the switch control map 102 is computed by Content Detector 122 in the SCMG 102 from the incoming video (2D/3D/Mixed) stream. Generation of the switch control map 120 by the Content Detector 122 can be achieved in many different ways. In one example, for a 2-view stereoscopic display, each image/frame is divided into two sub-images/frames, an odd column sub-image/frame and an even column sub-image/frame. Then, statistical properties, such as a histogram, can be obtained from odd column sub-image and compared with those obtained from even column sub-image. Further, the luminance pixel value difference between the odd column sub-image and the even column sub-image can be obtained. Using the statistical properties and/or the luminance pixel value difference, an estimate of disparity between the odd column and the even column sub-images is computed to determine the viewing mode of each switching unit.

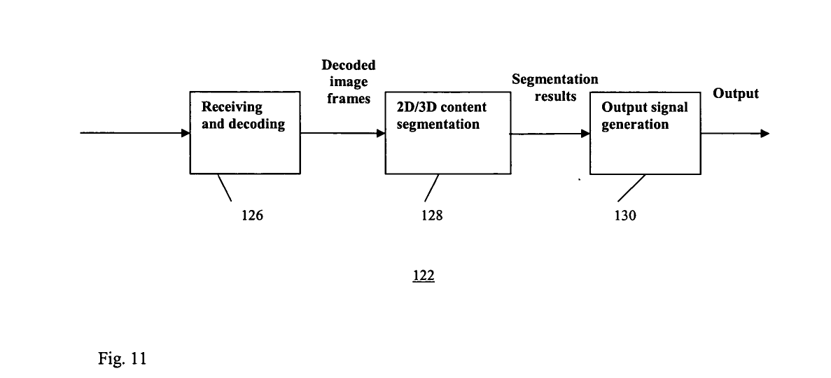

FIG. 11 shows a block diagram of an example implementation of the Content Detector 122 according to an embodiment of the present invention. In the Receiver/Decoder block 126, the input video is received and decoded into decoded image frames. Then, the Content Segmentation unit 128 analyses the incoming frames, and the segmentation results are provided to the Output Signal Generator 130 that generates a map indicating which portion of the display is in 2D or 3D mode. Output of the Signal Generator 130 is provided to the Switch Controller 104 (FIG. 1).

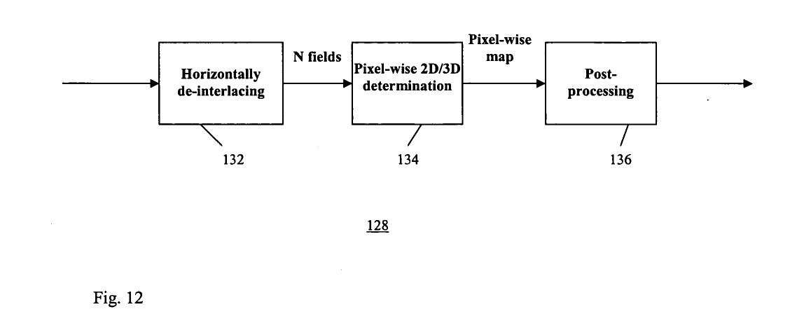

FIG. 12 shows a block diagram of an example implementation of a 2D/3D Content Segmentation unit 128 of FIG. 11, wherein analysis of the incoming video is performed. In the Content Segmentation unit 128, after de-interlacing (e.g., horizontal or diagonal) of the incoming image frame in a de-interlacer 132, the pixel-wise 2D/3D determination unit 134 performs analysis based on very fast pixel luminance comparisons and/or local statistical properties of the window around the pixel (as described). The pixel wise result map from the unit 134 is then grouped within a post processor 136 which uses morphological operators. Depending on the type of output display, the present invention has different embodiments of sending out video signals that could properly be displayed.

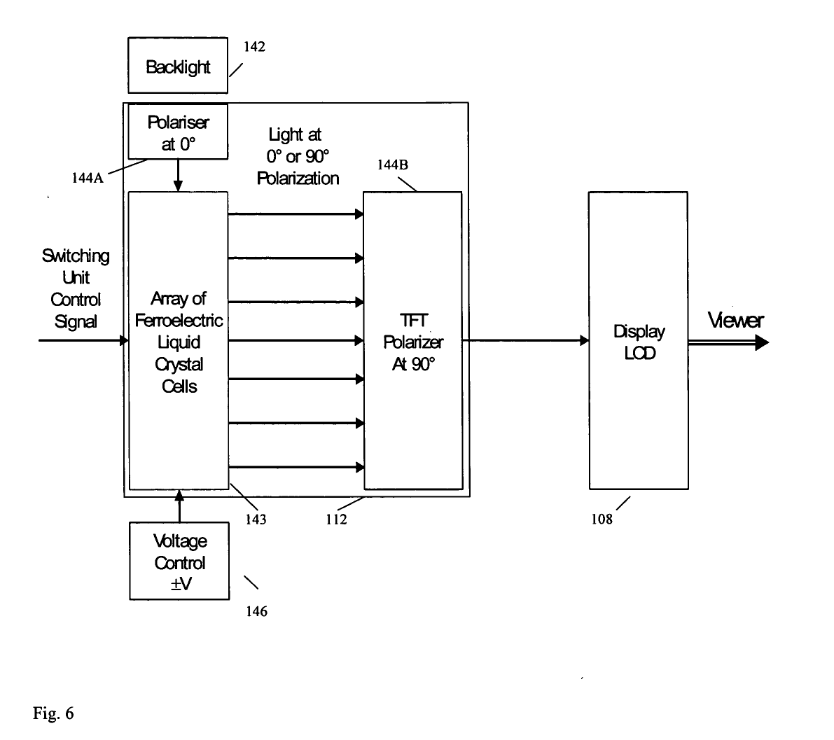

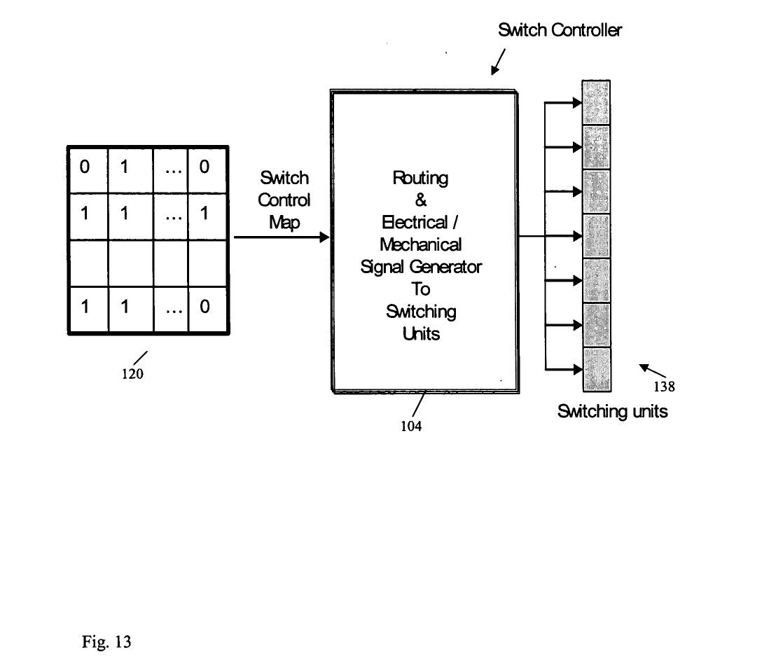

Referring to the example block diagram of FIG. 13, in one embodiment the Switch Controller 104 has the following input and output pair: The input comprises bitmap containing the switch control map 120. The output comprises the control signals to the switching units 138 (described above). The Switch Controller 104 functions as a translator between the switch control map 120 and the switching units 138. A switching unit 138 is a general concept, an example implementation of which is the switching light generator with the parallax barrier. For example, if each switching unit 138 works as a voltage-activated light switch (e.g., ferroelectric liquid crystal cell in FIG. 6), the switch controller 104 reads in values of the switch control map 120 and outputs an appropriate voltage signals (+V or −V) to the corresponding switching unit 138.

In one embodiment, the Switching Mechanism 106 has the following input and output pair: The input comprises said switching unit control signal from the Switch Controller 104. The output comprises a pattern of light that goes through the display panel 114 (FIG. 1). The Switching Mechanism 106 adjusts the light that goes through the display panel 114, wherein a switching light generator 110 sends out light such that the switching units 138 are in either 2D or 3D mode as specified by the switching unit control signals. For example, if a switching light generator 110 works by changing the polarization of light that goes through different portions of the parallax barrier 112, the output is the light with a corresponding pattern of polarization.

In one example, the parallax barrier 112 has the following input and output pair: The input comprises a pattern of light indicating the 2D or 3D modes of each switching unit 138. The output is a pattern of light steered in such directions to create 3D viewing effects on certain regions of the display panel 108 and 2D viewing effects on the rest of the panel 108. If the input is the light with a corresponding pattern of polarization, the parallax barrier 112 comprises simply a polarizer at a certain polarization angle (FIG. 6).

In one embodiment, the Display Panel 108 (FIGS. 1 and 6) has the following input and output pair: The input comprises said pattern of light steered in such directions to create 3D viewing effects on certain regions of the screen. The output comprises the 2D, 3D, or mixed 2D/3D images displayed to the viewer. The multi-view 3D display with N-views requires that N columns of images from N different views are interlaced such that a light pattern from the parallax barrier illuminates the i^{th} column corresponding to the i^{th} view towards the i^{th} viewing angle of the viewer for i=1 . . . N.

An example operation of a 3D display system 100 with flexible switching between 2D/3D viewing modes according to the present invention is now described. A 2-view autostereoscopic display with horizontal-parallax-only using the parallax barrier 112 and LCD panel 108, is utilized.

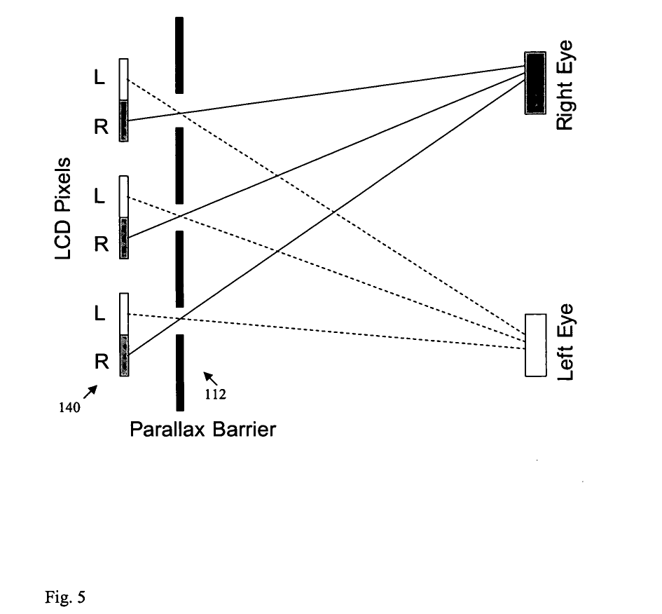

The input to the 2-view display includes a column-by-column interlace of two images obtained from 2 slightly different viewing angles. Referring to the example in FIG. 5, the odd columns of the input are from the left view, marked “L”, and the even columns of the input are from the right view, marked “R”. The odd columns are directed to the right eye through the parallax barrier 112 placed in front of the image pixels 140. The even columns are directed to the left eye through the same parallax barrier 112. Since the left and right eyes receive a slightly different images of the same scene, the brain fuses these two images and generate a 3D visual sensation (binocular parallax).

To turn the 3D mode of the entire screen on and off using the parallax barrier 112, the parallax barrier pattern is changed (switched), as shown in FIG. 1A to FIG. 1B, or vice versa. To change the 2D/3D viewing mode of the portions of the screen in a flexible manner, the parallax barrier pattern is changed, for example as shown in FIG. 2 or FIG. 3.

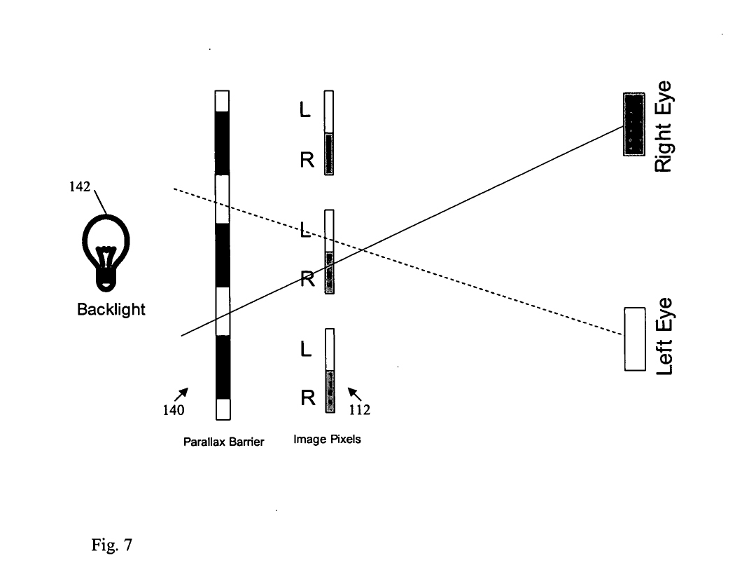

The example herein achieves the flexible switching of 2D/3D viewing modes using light polarization (autostereoscopy) as shown in FIG. 7 wherein the parallax barrier 112 is placed behind the image pixels 140. When the parallax barrier 112 is activated, the light from a backlight 142 passing through the parallax barrier 112 is directed in such a way that the left view pixels, marked “L”, are directed towards the left eye, while the right view pixels, marked “R”, are directed towards the right eye. Thus, if the parallax barrier 112 can be controlled electrically so that the shape, size, and location of the parallax barrier 112 is changed as in FIG. 2 and FIG. 3, to achieve flexible switching of 2D/3D viewing mode within the display 108.

As shown in FIG. 6, in one example the parallax barrier 112 comprises an array 143 of ferroelectric liquid crystal cells and two crossed polarizers, 144A-B. When a positive electric field +E is applied in the z-direction via a voltage control 146, the molecular orientation of ferroelectric liquid crystals 143 (in smectic-C phase) is tilted at +θ°. When a negative electric field −E is applied, the molecular orientation is at −θ°. When 2θ=45°, the wave undergoes a retardation L. By selecting the thickness of the cells 143 appropriately, the retardation becomes L=π, and the plane of polarization rotates at 90°.

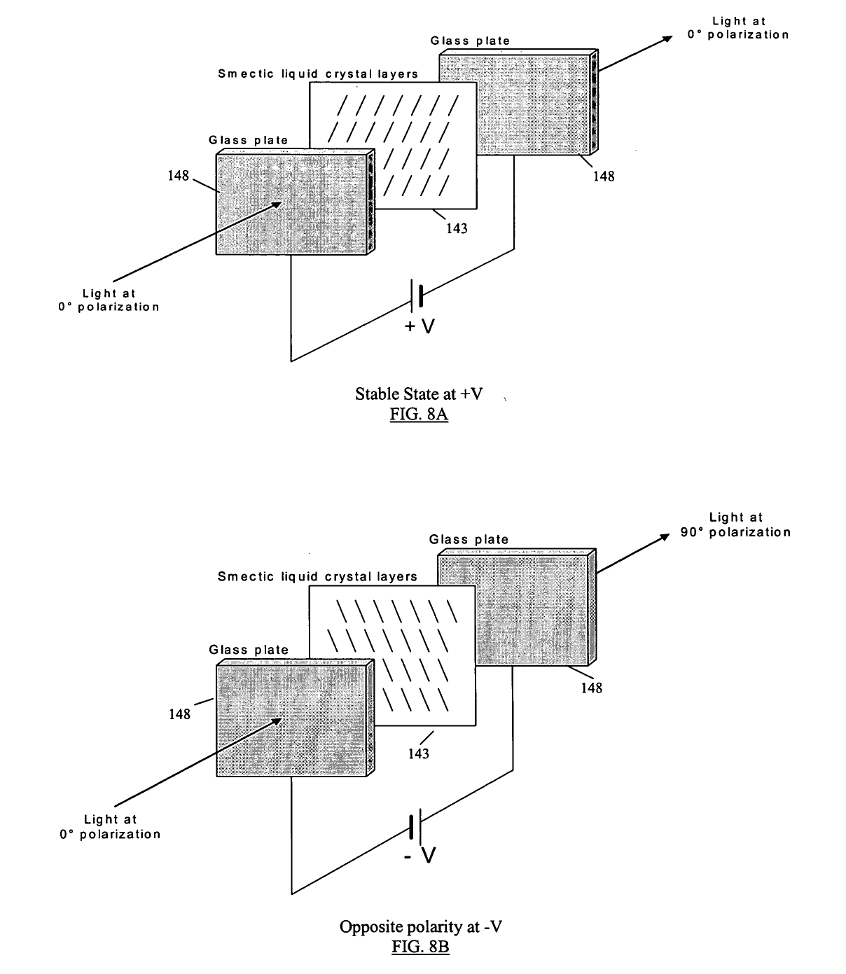

The incoming light goes through the first polarizer 144A at θ°. Each ferroelectric liquid crystal cell, corresponding to a switching unit, is applied either a voltage +V or −V depending on the parallax barrier mode. Referring to the examples in FIGS. 8A-B, when the cell is applied with +V, the output light from the cell 143 placed between glass plates 148 is at θ° polarization (FIG. 8A). When the cell is applied with −V, the output light from the cell is at (θ+90)° polarization (FIG. 8B). The output light goes through the second polarizer 144B at (θ+90)°. The light from +V cell is blocked by the second polarizer while the light from −V cell goes through, generating the flexible parallax barrier pattern that illuminates the display LCD 108. The response time of the ferroelectric liquid-crystal described above (FIG. 6) is typically less than 20 microseconds at room temperature with the switching voltage at 10V.

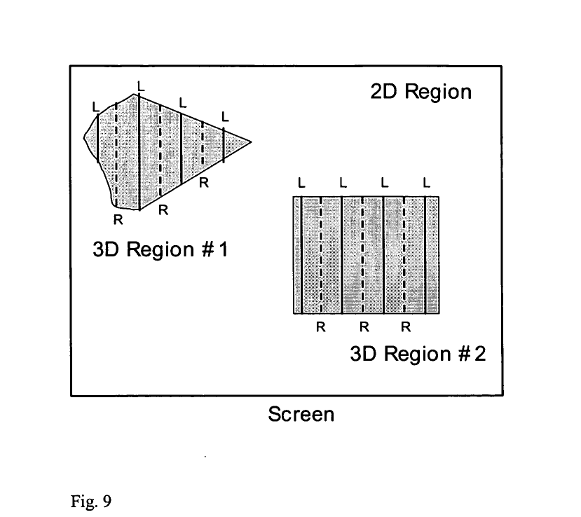

FIG. 9 shows the mixed 2D/3D video input. The parts to be displayed in 3D (e.g., 3D Region #1 and 3D Region #2) have columns from 2-views (L and R) interlaced. In order to have a 2-view 3D display of an image, the Left-view (L) and Right-view (R) images are interlaced column-by-column. FIG. 9 shows such interlace process applied to the 3D portions of the display.

As such, the present invention provides a method, and display system, for displaying a mixture of 2D and 3D video content. Switching devices turn the 2D/3D mode of different portions of the screen on and off independently and automatically. Any type (2D, 3D, mixed) of video content can be displayed on any part of the display screen simultaneously. The switching between different modes (2D, 3D, mixed) is performed automatically according to input control signals received from an internal device, or determined by a 2D/3D content detector in a computer, set-top-box, and/or cable/satellite tuner/receiver.

The present invention has been described in considerable detail with reference to certain preferred versions thereof; however, other versions are possible. Therefore, the spirit and scope of the appended claims should not be limited to the description of the preferred versions contained herein.

What is claimed is:

1. A display system for automatic switching of 2D/3D viewing modes, comprising:
a receiving device that receives video stream signals comprising 2D, 3D, or mixed 2D/3D video content;
a controller that controls 2D/3D viewing mode in one or more regions on a display screen of a display apparatus as a function of the received video stream signals.

2. The display system of claim 1 wherein the video stream signals further include auxiliary display information about each 2D/3D region, such that when the auxiliary data is present, the controller controls 2D/3D viewing mode in one or more regions on the display screen as a function of said auxiliary data.

3. The display system of claim 1 wherein the controller includes a content detector that detects the 2D/3D content of the video stream signals and generates a switch control map that indicates 2D/3D viewing mode in one or more regions on the display screen.

4. The display system of claim 3 further comprising a switching device that uses the switch control map to switch 2D/3D viewing mode in one or more regions on the display screen.

5. The display system of claim 4 wherein the switching devices control switching units within the display apparatus, such that each switching unit is switched between 2D and 3D viewing modes as a function of the switch control map.

6. The display system of claim 5 wherein each switching unit comprises a display area on the display screen that can be switched between 2D and 3D modes.

7. The display system of claim 5 wherein each switching unit comprises the smallest display area on the display screen that can be switched between 2D and 3D modes.

8. The display system of claim 5 wherein each switching unit comprises a pixel on the display screen.

9. The display system of claim 1 wherein the controller further automatically toggles between 2D and 3D viewing modes in one or more regions on the display screen within a single screen image frame, as a function of the received video stream signals.

10. The display system of claim 1 wherein the controller further includes:
a switch control map generator that receives data input including 2D, 3D, or mixed 2D/3D video stream signals and generates a switch control map automatically as a function of the incoming video stream signal;
a mode switch that detects auxiliary data input including a pre-computed switch control map, wherein when the auxiliary data input is present the mode switch outputs the pre-computed switch control map, otherwise, the mode switch outputs the switch control map generated by the switch control map generator.

11. The display system of claim 10 wherein the switch control map generator generates the switch control map only when the auxiliary date input is not present.

12. The display system of claim 10 further comprising a switching controller that receives as input a switch control map, translates the switch control map to appropriate control signals, and outputs the control signals to a switching mechanism for switching one or more regions on the display screen between 2D and 3D modes.

13. The display system of claim 12 wherein the switching mechanism, based on the control signals, selects light directions according to the switch control map to switch one or more regions on the display screen between 2D and 3D viewing modes.

14. The display system of claim 13 wherein the switching mechanism comprises light switch cells and a polarizer that changes the polarization of the FLC cells as a function of the control signals according to the switch control map.

15. The display system of claim 14 wherein the light switch cells receive light at θ° polarization and output light at either θ° (θ+90)° polarization according to the corresponding selected 2D/3D viewing mode.

16. The display system of claim 15 wherein the polarizer receives light at either θ° or (θ+90)° polarization and outputs light at θ° polarization only.

17. The display system of claim 1 wherein the display screen displays an array of image pixels including a portion with 3D content and another portion with 2D content.

18. The display system of claim 17 wherein the display screen comprises a display panel that receives as input the array of image pixels to be displayed and displays received 2D, 3D, and/or mixed 2D/3D video stream signals to a viewer.

19. A display method for displaying 2D/3D video content, comprising the steps of:
receiving video stream signals comprising 2D, 3D, or mixed 2D/3D video content; and
controlling 2D/3D viewing mode in one or more regions on a display screen of a display apparatus as a function of the received video stream signals.

20. The method of claim 19 wherein:
the video stream signals further include display information about each 2D/3D region; and
when the auxiliary data is present, the step of controlling the 2D/3D viewing mode further includes the steps of controlling 2D/3D viewing mode in one or more regions on the display screen as a function of said auxiliary data.

21. The method of claim 19 wherein the step of controlling the 2D/3D viewing modes further includes the steps of detecting the 2D/3D content of the video stream signals and generating a switch control map that indicates 2D/3D viewing mode in one or more regions on the display screen.

22. The method of claim 21 further including the step switching between 2D and 3D viewing modes in one or more regions on the display screen based on the switch control map.

23. The method of claim 22 wherein the step of switching further includes the steps of controlling switching units within the display apparatus, such that each switching unit is switched between 2D and 3D viewing modes as a function of the switch control map.

24. The method of claim 23 wherein each switching unit comprises a display area on the display screen that can be switched between 2D and 3D modes.

25. The method of claim 23 wherein each switching unit comprises the smallest display area on the display screen that can be switched between 2D and 3D modes.

26. The method of claim 23 wherein each switching unit comprises a pixel on the display screen.

27. The method of claim 19 wherein the step of controlling between 2D and 3D view modes further includes the steps of automatically toggling between 2D and 3D viewing modes in one or more regions on the display screen within a single screen image frame, as a function of the received video stream signals.

28. The method of claim 19 wherein the step of controlling between 2D and 3D view modes further includes the steps of receiving as input a switch control map, translating the switch control map to appropriate control signals, and based on the control signals switching one or more regions on the display apparatus between 2D and 3D modes.

29. The method of claim 28 wherein the step of switching based on the control signals further includes the steps of selecting light directions according to the switch control map to switch one or more regions on the display screen between 2D and 3D viewing modes.

30. The method of claim 29 wherein the steps of switching further includes the steps of switching voltage-activated light switch cells as a function of the control signals according to the switch control map to change one or more regions on the display screen between 2D and 3D viewing modes.

31. The method of claim 30 wherein the voltage-activated light switch cells receive light at θ° polarization and output light at either θ° or (θ+90)° polarization according to the corresponding selected 2D/3D viewing mode.

32. The method of claim 31 wherein a polarizer changes the polarization of the voltage-activated light switch cells as a function of the control signals according to the switch control map, such that the polarizer receives light at either θ° or (θ+90)° polarization and outputs light at θ° polarization only.

33. The method of claim 19 wherein the display screen displays an array of image pixels including a portion with 3D content and another portion with 2D content.
